(19) United States
(12) Patent Application Publication
(10) Pub. No.: US 2026/0169420 A1
(43) Pub. Date: Jun. 18, 2026

(54) STATIC ELIMINATION APPARATUS AND IMAGE FORMING SYSTEM

(71) Applicant: CANON KABUSHIKI KAISHA, Tokyo (JP)

(72) Inventors: HIROKI KOBAYASHI, Ibaraki (JP); TOSHIFUMI OIKAWA, Ibaraki (JP); HIROYUKI EDA, Ibaraki (JP); KAZUHIRO AKIBA, Chiba (JP)

(21) Appl. No.: 19/418,070

(22) Filed: Dec. 12, 2025

(30) Foreign Application Priority Data
Dec. 17, 2024 (JP) 2024-220510

(51) Int. Cl. G03G 15/00; G03G 21/02

(52) U.S. Cl. CPC G03G 15/6573; G03G 15/5016; G03G 15/55; G03G 21/02; G03G 2215/00649

(57) ABSTRACT

A static elimination apparatus includes a non-contact static elimination unit including an electrode portion and configured to eliminate static charge from a sheet, without contacting the sheet, and a control unit configured to perform, using the non-contact static elimination unit, static elimination processing for eliminating static charge from a plurality of sheets, and perform detection processing for detecting whether a maintenance of the electrode portion is necessary, wherein, in a case where a cumulative operation time as a total of an operation time of the non-contact static elimination unit is equal to or greater than a first threshold value, the control unit performs the detection processing, and wherein, in a case where the operation time of the non-contact static elimination unit in a single job is equal to or greater than a second threshold value smaller than the first threshold value, the control unit performs the detection processing.

### BACKGROUND

### Field of the Technology

The present disclosure relates to a static elimination apparatus and an image forming system.

### Description of the Related Art

In an image forming apparatus for forming an image on a sheet, the sheet may become charged during image formation on the sheet, causing discharged sheets to stick together and resulting in stacking failures. To address this, an image forming system including a non-contact static elimination unit that eliminates static charge from the sheet without contacting the sheet has been proposed. However, when the non-contact static elimination unit is used continuously to eliminate static charge from sheets without contacting the sheets, dust and organic matter in the air may deposit on an electrode portion of the non-contact static elimination unit, reducing the static elimination performance of the non-contact static elimination unit. Thus, it is desirable to perform maintenance on the non-contact static elimination unit at an appropriate timing. In Japanese Patent Laid-Open No. 2024-107617, a detection process is executed to determine whether maintenance of the non-contact static elimination unit is necessary when the number of sheets from which static charge is eliminated by the non-contact static elimination unit reaches a threshold.

However, depending on the time taken for a job or the number of sheets to be used for a job, the detection processing cannot be performed at an appropriate timing, so that the execution of the job may continue while the static elimination capability of the non-contact static elimination unit remains degraded.

### SUMMARY

Embodiments of the present disclosure are directed to providing a static elimination apparatus and an image forming system capable of performing, at an appropriate timing, the detection processing for determining whether the maintenance of the non-contact static elimination unit is necessary.

According to an aspect of the present disclosure, a static elimination apparatus includes a non-contact static elimination unit and a control unit. The non-contact static elimination unit includes an electrode portion for generating ions and is configured to eliminate static charge from a sheet on which an image has been formed by an image forming unit, without contacting the sheet. The control unit is configured to perform, using the non-contact static elimination unit, static elimination processing for eliminating static charge from a plurality of sheets conveyed from the image forming unit during execution of a job and perform detection processing for detecting whether a maintenance of the electrode portion is necessary after completion of the job. In a case where a cumulative operation time as a total of an operation time of the non-contact static elimination unit since a previous execution of the detection processing is equal to or greater than a first threshold value, the control unit performs the detection processing. In a case where the operation time of the non-contact static elimination unit in a single job is equal to or greater than a second threshold value smaller than the first threshold value, the control unit performs the detection processing.

According to another aspect of the present disclosure, a static elimination apparatus includes a non-contact static elimination unit and a control unit. The non-contact static elimination unit includes an electrode portion for generating ions and is configured to eliminate static charge from a sheet on which an image has been formed by an image forming unit, without contacting the sheet. The control unit is configured to perform, using the non-contact static elimination unit, static elimination processing for eliminating static charge from a plurality of sheets conveyed to the non-contact static elimination unit during execution of a job and perform, after the static elimination processing, detection processing for detecting whether a maintenance of the electrode portion is necessary after completion of the job. In a case where a cumulative number of sheets as a total number of sheets that have passed through the non-contact static elimination unit since a previous execution of the detection processing is equal to or greater than a first threshold value, the control unit performs the detection processing. In a case where the number of sheets that have passed through the non-contact static elimination unit in a single job is equal to or greater than a second threshold value smaller than the first threshold value, the control unit performs the detection processing.

Other features of various embodiments of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an image forming system.

FIG. 2 is a schematic diagram illustrating a static elimination apparatus.

FIG. 3 illustrates the image forming system.

FIG. 4 is a perspective view illustrating an upper unit and a lower unit in a state where the upper unit is closed.

FIG. 5 is a perspective view illustrating the upper and the lower units in a state where the upper unit is open.

FIG. 6 is a perspective view illustrating a conveyance guide of a non-contact static elimination unit.

FIG. 7 is a control block diagram of an image forming apparatus and the static elimination apparatus.

FIGS. 8A and 8B illustrate screens displayed on a user operation unit.

FIG. 9 is a flowchart illustrating control performed by a static elimination control unit.

FIG. 10 illustrates an example of a modified flowchart illustrating control performed by the static elimination control unit.

### DESCRIPTION OF THE EMBODIMENTS

Embodiments of the present disclosure will be described below with reference to the accompanying drawings. Unless otherwise specifically stated, dimensions, materials, and relative positions of components of an image forming apparatus and a static elimination apparatus are not intended to limit the scope of the present disclosure to those particulars. In addition, elements indicated by the same reference numerals in the drawings represent identical structures or functions, and repeated explanations thereof are omitted as appropriate.

### First Embodiment

### Overall Configuration of Image Forming Apparatus

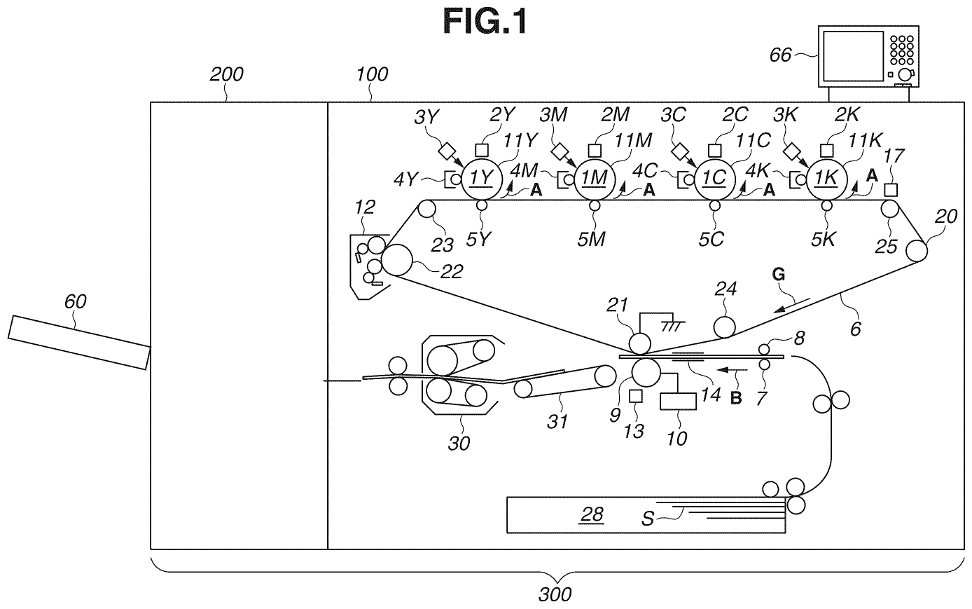

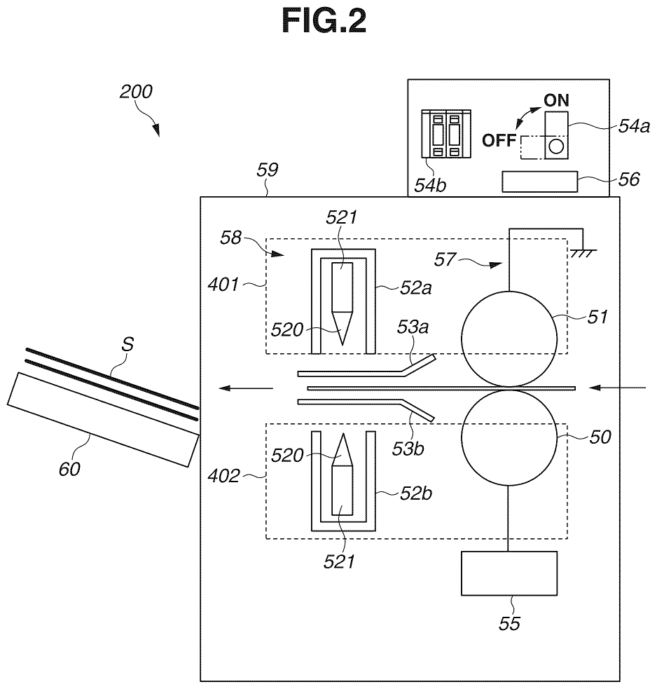

FIG. 1 is a schematic diagram illustrating an image forming system 300 according to a first embodiment. The image forming system 300 includes an image forming apparatus 100 for forming an image on a sheet S and includes a static elimination apparatus 200 for eliminating static charge from the sheet surface. In the schematic diagram of the image forming system 300 in FIG. 1, detailed descriptions of the static elimination apparatus 200 are omitted. A configuration of the static elimination apparatus 200 will be described below (see FIG. 2).

Initially, an overall configuration of the image forming apparatus 100 will be described. The image forming apparatus 100 forms an image on a sheet by using the electrophotographic process. The image forming apparatus 100 includes a plurality of (four different) image forming units 11Y, 11M, 11C, and 11K for forming a yellow (Y), a magenta (M), a cyan (C), and a black (K) image, respectively. These image forming units 11Y, 11M, 11C, and 11K are disposed in a row in the direction of the movement of an image transfer surface which is approximately horizontally disposed on an intermediate transfer belt 6 (described below). The image forming units 11 include photosensitive drums 1 (1Y, 1M, 1C, and 1K), charging apparatuses 2 (2Y, 2M, 2C, and 2K), exposure apparatuses 3 (3Y, 3M, 3C, and 3K), development apparatuses 4 (4Y, 4M, 4C, and 4K), and primary transfer rollers 5 (5Y, 5M, 5C, and 5K).

As illustrated in FIG. 1, the photosensitive drums (latent image bearing members) 1Y, 1M, 1C, and 1K rotate in the direction of the corresponding arrows A. The surfaces of the photosensitive drums 1Y, 1M, 1C, and 1K are uniformly charged by charging apparatuses 2Y, 2M, 2C, and 2K, respectively. The exposure apparatuses 3Y, 3M, 3C, and 3K expose the surfaces of the photosensitive drums 1Y, 1M, 1C, and 1K to light based on image information to form electrostatic latent images on the surfaces of the photosensitive drums 1Y, 1M, 1C, and 1K, respectively. The development apparatuses 4Y, 4M, 4C, and 4K include toner of yellow (Y), magenta (M), cyan (C), and black (K), respectively. The development apparatuses 4Y, 4M, 4C, and 4K develop the electrostatic latent images by using the corresponding toner to form toner images on the photosensitive drums 1Y, 1M, 1C, and 1K, respectively.

According to the present embodiment, the image forming apparatus 100 employs a reversal developing method, in which toner is deposited onto exposure portions of an electrostatic latent image to develop the image.

The intermediate transfer belt 6 is disposed to be in contact with the surfaces of the photosensitive drums 1Y, 1M, 1C, and 1K. The intermediate transfer belt 6 is stretched over a plurality of support rollers 20, 21, 22, 23, 24, and 25, and rotates in the direction of the arrow G at a rotational speed of 150 to 470 mm/s. According to the present embodiment, the support rollers 20 are tension rollers for controlling the tension of the intermediate transfer belt 6 to a constant value. The support roller 22 is a drive roller for the intermediate transfer belt 6. The support roller 21 is an inner roller for secondary transfer. A secondary transfer outer roller 9 nips the sheet S at a secondary transfer nip (secondary transfer portion) between the outer roller 9 and the intermediate transfer belt 6 and conveys the sheet S through the secondary transfer nip.

The primary transfer rollers 5Y, 5M, 5C, and 5K are disposed to face the photosensitive drum 1Y, 1M, 1C, and 1K across the intermediate transfer belt 6 to form primary transfer nips (primary transfer portions) between the primary transfer rollers 5Y, 5M, 5C, and 5K and the photosensitive drums 1Y, 1M, 1C, and 1K, respectively. In synchronization with the toner images of different colors on the surfaces of the photosensitive drums 1Y, 1M, 1C and 1K conveyed to the corresponding primary transfer nips, a transfer bias, having been subjected to constant-voltage control and having the opposite polarity to the toner images, is applied to the primary transfer rollers 5Y, 5M, 5C, and 5K. Thus, the toner images on the photosensitive drums 1Y, 1M, 1C, and 1K are transferred to the intermediate transfer belt 6 (primary transfer).

A belt image reading sensor 17 is disposed in the vicinity of the intermediate transfer belt 6. The belt image reading sensor 17 reads images having been transferred to the intermediate transfer belt 6. For example, the belt image reading sensor 17 is an optical sensor that irradiates an image on the intermediate transfer belt 6 with light and receives the reflected light to read the image. For example, the belt image reading sensor 17 reads an adjustment image used for adjusting an image forming condition, formed on the intermediate transfer belt 6. A Central Processing Unit (CPU) 61 of the image forming apparatus 100 (hereinafter referred to as main CPU 61), described below, analyzes a result of reading the adjustment image by the belt image reading sensor 17 and feeds the result back to the image forming conditions for calibration.

The sheet S stored in a cassette 28 is conveyed to a registration roller 8 by feed rollers and other components, and then temporarily stopped. The registration roller 8 conveys the sheet S to the secondary transfer portion in synchronization with the conveyance of the toner images on the intermediate transfer belt 6 to the secondary transfer nip. A pre-secondary transfer conveyance guide 14 improves the accuracy in conveying the sheet S to the secondary transfer portion.

A high-voltage application unit 10 applies a transfer bias, which is controlled to a constant voltage and has the polarity opposite to that of the toner image, to the secondary transfer outer roller 9. Thus, the toner images on the intermediate transfer belt 6 are transferred onto the sheet S (secondary transfer). According to the present embodiment, the toner has a negative polarity, so that a positive voltage is applied to the secondary transfer outer roller 9. The support roller 21, which is the secondary transfer inner roller is electrically connected to the ground. However, the high-voltage application unit 10 may apply a transfer bias, which is controlled to a constant voltage and has the same polarity as the toner, to the support roller 21, which is the secondary transfer inner roller, and the secondary transfer outer roller 9 may be electrically connected to the ground.

A pre-fixing conveyance device 31 includes a belt member configured to rotate. The sheet S, onto which the toner image has been transferred, is placed on the belt which is rotating, so that the sheet S is conveyed. The fixing apparatus 30 applies heat and pressure to the sheet S to fix the toner images to the sheet S. A belt cleaning unit 12 electrostatically collects residual toner that remains on the intermediate transfer belt 6 without being transferred to the sheet S during secondary transfer, to clean the belt. The intermediate transfer belt 6 having been cleaned is repetitively used for image formation.

A main display unit 66, which serves as the primary display for the image forming apparatus 100, is disposed on the exterior of the image forming system 300. The main display unit 66 may be directly fixed to the exterior of the image forming system 300 or may be connected to an apparatus by a cable and placed on top of the apparatus. The main display unit 66 may communicate wirelessly via Bluetooth® with the main body of the image forming apparatus 100 without being connected to the main body of the image forming apparatus 100 by a cable.

### Overall Configuration of Elimination Apparatus

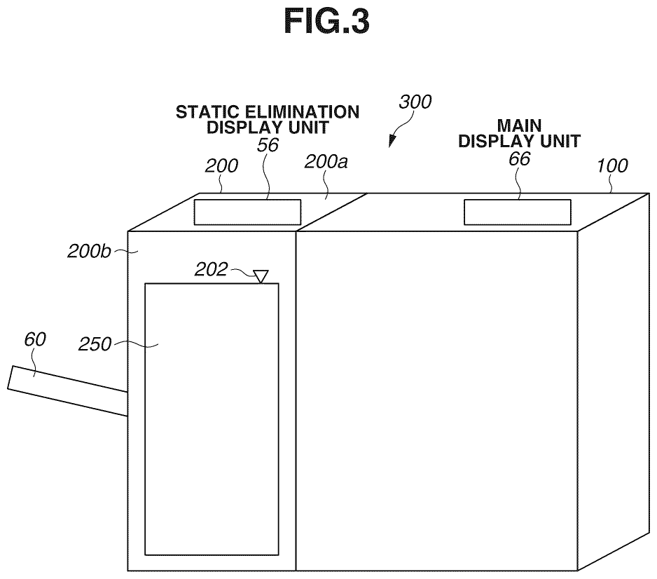

FIG. 2 illustrates an overall configuration of the static elimination apparatus 200. FIG. 3 illustrates an image forming system 300. The static elimination apparatus 200 is disposed downstream of the image forming apparatus 100 in a sheet conveyance direction. In the above-described secondary transfer, a high voltage with a positive polarity is applied to the secondary transfer outer roller 9 (see FIG. 1). Thus, after the sheet S has passed through the secondary transfer portion, the lower surface of the sheet becomes positively charged, while the upper surface of the sheet S is negatively charged due to dielectric polarization. Therefore, if the static elimination processing is not performed and sheets are stacked in an ejection tray 60, the contact surfaces of stacked sheets S will have opposite polarities, which may cause the sheets S to stick together due to electrostatic force. To prevent sheets from sticking together due to the electrostatic force, the static elimination apparatus 200 according to the present embodiment removes static charge from the surfaces (upper and lower surfaces) of the sheets using a contact static elimination unit 57 and a non-contact static elimination unit 58.

The static elimination apparatus 200 may be directly connected to the image forming apparatus 100 or connected to the image forming apparatus 100 via a sheet processing apparatus, such as an inserter, between the image forming apparatus 100 and the static elimination apparatus 200. The image forming apparatus 100 and the static elimination apparatus 200 may be integrally formed to configure the image forming apparatus 100. The image forming apparatus 100 and the static elimination apparatus 200 may be integrally formed to configure the static elimination apparatus 200. In other words, the housings of the image forming apparatus 100 and the static elimination apparatus 200 may be the same or may be separated into a plurality of units.

The static elimination apparatus 200 includes a housing 59, the contact static elimination unit 57, the non-contact static elimination unit 58, a conveyance guide 53, and a control unit (not illustrated) for controlling the entire static elimination apparatus 200. The static elimination apparatus 200 further includes a static elimination operation unit 54 and a static elimination display unit 56. The sheet S conveyed from the image forming apparatus 100 has its static charge roughly removed by the contact static elimination unit 57 which is configured to eliminate static charge from a sheet while the sheet is in contact with the contact static elimination unit 57. Then, any remaining charge that could not be removed by the contact static elimination unit 57 is eliminated from the sheet S by the non-contact static elimination unit 58, which is configured to elimination static charge from a sheet while the sheet is not in contact with the non-contact static elimination unit 58. Then, the sheet S is ejected from the static elimination apparatus 200. The contact static elimination unit 57, the non-contact static elimination unit 58, and the static elimination operation unit 54 will be described in detail below.

The static elimination display unit 56 includes a light emitting diode (LED), and, as illustrated in FIG. 3, is disposed on a top surface 200a (upper surface of the static elimination apparatus 200) of the exterior covering the housing 59. The static elimination display unit 56 may be disposed on a front surface 200b (front surface of the static elimination apparatus 200) of the exterior of the static elimination apparatus 200. The front surface 200b refers to the surface corresponds to the front of the static elimination apparatus 200, and includes an inclined surface that intersects the vertical direction. The static elimination display unit 56 disposed on the top surface 200a or the front surface 200b of the exterior of the static elimination apparatus 200 allows the user to check information displayed by the static elimination display unit 56 when using the static elimination apparatus 200. In other words, it is sufficient for the static elimination display unit 56 to be disposed on the outside of the exterior. For example, the static elimination display unit 56 may be directly fixed to the exterior or may be connected to the static elimination apparatus 200 by a cable and disposed on top of the static elimination apparatus 200. Alternatively, the static elimination display unit 56 may communicate wirelessly with the main body of the static elimination apparatus 200 via Bluetooth® without being connected thereto by a cable. The static elimination display unit 56 is turned ON or OFF based on the states of an ionizer 52 (including 52a and 52b) in the non-contact static elimination unit 58.

The static elimination display unit 56 according to the present embodiment includes an LED. However, the present embodiment is not limited thereto. The static elimination display unit 56 may include a liquid crystal display. The static elimination display unit 56 may display not only information about the non-contact static elimination unit 58 but also information about the contact static elimination unit 57.

The static elimination apparatus 200 is provided with a door 250 (see FIG. 3), which forms the front surface 200b of the static elimination apparatus 200. The door 250 is configured to be opened and closed with respect to the housing 59 by an open/close mechanism (not illustrated). The opening and closing of the door 250 of the static elimination apparatus 200 is detected by a door sensor 202. The user opens the door 250 to access an upper unit 401 and a lower unit 402. Specifically, the upper unit 401 includes a static elimination opposing roller 51 and an ionizer 52a as illustrated in FIG. 2. The lower unit 402 includes a static elimination roller 50, an ionizer 52b, and the conveyance guide 53. The upper unit 401 is configured to be opened and closed with respect to the lower unit 402.

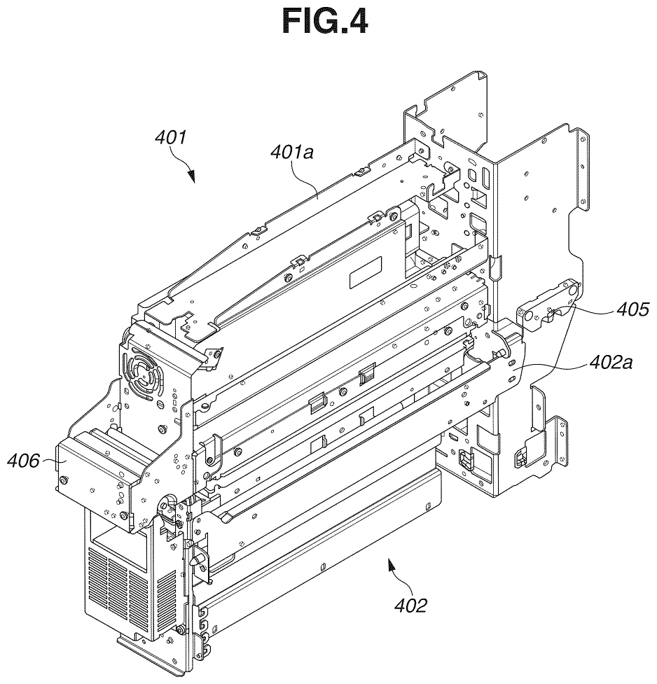

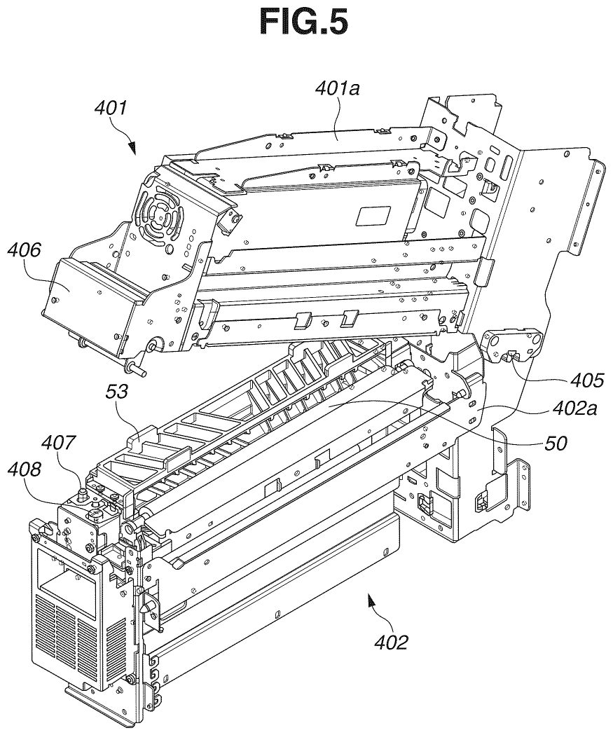

FIG. 4 illustrates a perspective view of the upper unit 401 and the lower unit 402 in a state where the upper unit 401 is closed. FIG. 5 illustrates a perspective view of the upper unit 401 and the lower unit 402 in a state where the upper unit 401 is open. The upper unit 401 includes an upper housing 401a formed of a sheet metal or the like, and the ionizer 52a is fixed to the upper housing 401a. The lower unit 402 includes a lower housing 402a formed of a sheet metal, and the ionizer 52b is fixed to the lower housing 402a. The lower unit 402 is fixed so as not to move relative to the housing 59 of the static elimination apparatus 200. On the other hand, the upper unit 401 is disposed to be rotatable about a rotating shaft 405 with respect to the lower unit 402. The upper unit 401 is provided with a handle 406. Since the upper unit 401 rotates inside the housing 59, the range in which the upper unit 401 can rotate is limited by the height of the top surface of the housing 59. More specifically, the upper unit 401 can rotate from the closed state to the position where the upper unit 401 comes into contact with the top surface of the housing 59.

The user needs to perform maintenance on electrode portions of the ionizer 52 to maintain the static elimination capability of the ionizer 52. The upper unit 401 is configured to be rotatable with respect to the lower unit 402, so that the user can access the electrode portion.

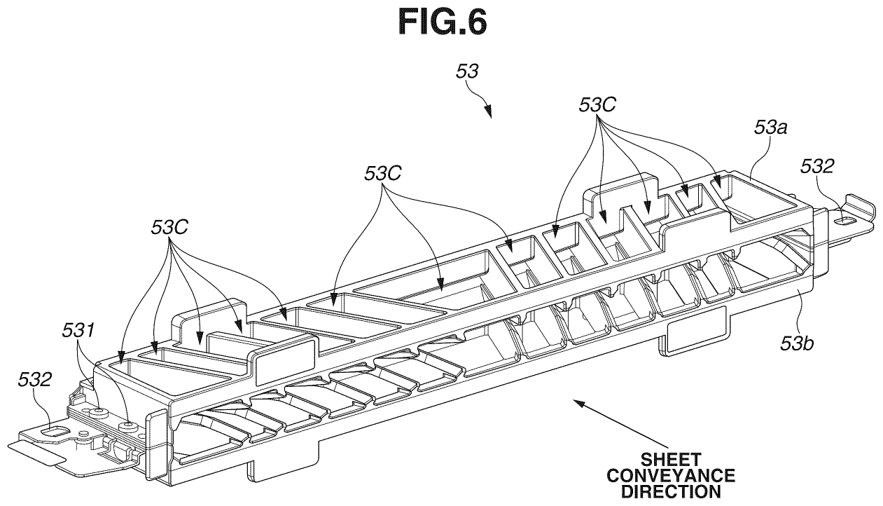

FIG. 6 is a perspective view of the conveyance guide 53 for guiding a sheet. The conveyance guide 53 has, outside the conveyance path in the width direction perpendicular to the sheet conveyance direction, two fitting holes 532 into which two projecting portions 407 (described below) are fitted. As illustrated in FIG. 5, the lower unit 402 is provided with two upwardly projecting portions 407, outside the conveyance path in the width direction perpendicular to the sheet conveyance direction. The two fitting holes 532 of the conveyance guide 53 fit into the corresponding projecting portions 407 of the lower unit 402, so that the conveyance guide 53 is positioned relative to the lower unit 402. The positioned conveyance guide 53 is detachably attached to the lower housing 402a of the lower unit 402 by a screw 408 serving as a fixing member disposed on the front side of the static elimination apparatus 200. However, the conveyance guide 53 may also be configured to be rotatable relative to the lower unit 402, and fixed to the lower unit 402 not only with the screw 408 but also with an engaging member.

In a case where a static elimination needle 520 of the ionizer 52a in the above-described configuration, the user opens the door 250, holds the handle 406, and upwardly rotates the upper unit 401. This allows the user to access the static elimination needle 520 of the ionizer 52a. When cleaning the static elimination needle 520 of the ionizer 52b, the user upwardly rotates the upper unit 401 and then removes the conveyance guide 53 from the lower unit 402. This allows the user to access the static elimination needle 520 of the ionizer 52b and perform the maintenance (cleaning) of the ionizer 52 of the non-contact static elimination unit 58.

When the user upwardly rotates the upper unit 401, the static elimination roller 50 and the static elimination opposing roller 51 are separated. Thus, if a sheet is jammed in the static elimination apparatus 200, the user can remove the jammed sheet by rotating the upper unit 401.

### Contact Static Elimination Unit

As illustrated in FIG. 2, the contact static elimination unit 57 includes the static elimination roller 50 and the static elimination opposing roller 51, which serve as a contact type elimination unit, and a high-voltage circuit board 55 for generating a high voltage to be applied to the static elimination roller 50. The static elimination roller 50 includes an elastic layer made of an ion conductive foam rubber, and a core metal. The static elimination roller 50 has an outer diameter of 20 to 25 mm. The resistance of the static elimination roller 50 is 1×10⁵ to 1×10⁸ Ω with application of a voltage of 2 kV at 23° C. and 50% relative humidity (RH) environmental measurement. The static elimination roller 50 is made of a material similar to that of the secondary transfer outer roller 9. The high-voltage circuit board 55 applies a static elimination voltage, which is a direct-current (DC) controlled to a constant voltage, to the static elimination roller 50. In this embodiment, as described above, the sheet S is conveyed to the static elimination apparatus 200 in a state where the upper surface of the sheet is negatively charged and the lower surface is positively charged. Thus, the high-voltage circuit board 55 applies a negative voltage to the static elimination roller 50, which is disposed below the sheet.

The static elimination opposing roller 51 is made of a stainless steel (Steel Use Stainless (SUS), specified by Japanese Industrial Standard) and electrically grounded (connected to ground). The static elimination opposing roller 51 uses a roller having an outer diameter of 20 to 25 mm and is disposed at a position facing the static elimination roller 50.

The static elimination roller 50 and the static elimination opposing roller 51 form a static elimination nip portion. A static elimination roller pair configured by the static elimination roller 50 and the static elimination opposing roller 51 coarsely remove static charge from the sheet S while the sheet S is in contact with the static elimination roller pair. The contact static elimination unit 57 according to the present embodiment directly applies a voltage to the sheet S while in contact with the sheet S, resulting in a high elimination effect. On the other hand, the contact static elimination unit 57 tends to cause large variations in the surface potential of the sheet S after static elimination, resulting in uneven elimination. Thus, the static elimination apparatus 200 according to the present embodiment includes the non-contact static elimination unit 58 downstream of the contact static elimination unit 57 in the sheet conveyance direction.

According to the present embodiment, the static elimination opposing roller 51 is driven to rotate by a static elimination drive motor (not illustrated), thus conveying the sheet S nipped at the static elimination nip portion. According to the present embodiment, the high-voltage circuit board 55 applies a negative voltage to the static elimination roller 50, and the static elimination opposing roller 51 is electrically grounded. However, the present embodiment is not limited thereto. The high-voltage circuit board 55 may apply a positive voltage to the static elimination opposing roller 51 by, and the static elimination roller 50 may be electrically grounded.

### Non-Contact Static Elimination Unit

The non-contact static elimination unit 58 includes the ionizer 52 (ionizers 52a and 52b), which is a non-contact type elimination unit. The ionizer 52a according to the present embodiment is a bar type ionizer that extends in the width direction perpendicular to the sheet conveyance direction. The ionizer 52a includes the static elimination needle 520 for producing ions, and an ionizer control unit 521 for controlling the ionizer 52a. The ionizer 52b has a configuration similar to that of the ionizer 52a. The ionizer 52 is disposed above and below the conveyance guide 53. More specifically, the ionizer 52a is disposed above the conveyance guide 53, and the ionizer 52b is disposed below the conveyance guide 53. The ionizer 52 is applied with an alternating-current (AC) bias to alternately emit positive and negative ions by corona elimination. This enables removing residual static charge on the upper and lower surfaces of the sheet S at the same time regardless of the polarity of residual static charge on the sheet S that has passed through the contact static elimination unit 57. According to the present embodiment, the static elimination effect, for the sheet S, of the non-contact static elimination unit 58 is smaller than that of the contact static elimination unit 57; however the variation in the surface potential of the sheet S after static elimination processing is smaller. Accordingly, the non-contact static elimination unit 58 can adjust the surface potential of the sheet S, which may have become uneven due to the contact static elimination unit 57. The static elimination needles 520 in this embodiment are examples of the electrode portions.

The conveyance guide 53, which is a member for guiding sheets, includes an upper conveyance guide 53a disposed to face the upper surface of the sheet S, and a lower conveyance guide 53b disposed to face the lower surface of the sheet S. The conveyance guide 53 is disposed below the ionizer 52a disposed on the upper unit 401, and above the ionizer 52b disposed on the lower unit 402, in the vertical direction. More specifically, the conveyance guide 53 is disposed between the ionizers 52a and 52b in the vertical direction. The sheet S having passed through the static elimination roller pair configured by the static elimination roller 50 and the static elimination opposing roller 51 is conveyed between the upper conveyance guide 53a and the lower conveyance guide 53b. The upper conveyance guide 53a and the lower conveyance guide 53b are made of insulating resin composed of polycarbonate (PC) and acrylonitrile-butadiene-styrene (ABS). The conveyance guide 53 according to the present embodiment has a volume resistivity of 1×10¹⁴ Ω·cm.

FIG. 6 illustrates a perspective view of the conveyance guide 53. To prevent ions produced from the static elimination needles 520, which are ion emitting portions, from being physically blocked by the conveyance guide 53, the upper conveyance guide 53a has openings 53c. More specifically, the upper conveyance guide 53a has a plurality of the openings 53c arranged in the width direction perpendicular to the sheet conveyance direction. Similarly, the lower conveyance guide 53b has a plurality of openings. The upper conveyance guide 53a and the lower conveyance guide 53b are fixed to each other by a plurality of screws 531 at both widthwise ends to configure a single guide unit (conveyance guide 53).

The present embodiment uses the ionizer 52 as a non-contact type elimination unit. However, the present embodiment is not limited thereto. For example, an AC corotron system, in which a high voltage is applied to a wire, may be used as a non-contact type elimination unit. According to the present embodiment, the ionizer 52 is disposed on the upper and lower surface sides of the sheet S. However, the present embodiment is not limited thereto. For example, the ionizer 52 may be disposed only on one side, either the upper or lower side, of the sheet. The high voltage to be applied may be a DC voltage, instead of an AC voltage.

### Configuration of Elimination Operation Unit

The present embodiment includes two different elimination units, namely, the contact static elimination unit 57 and the non-contact static elimination unit 58, and eliminate static charge from sheets by using the two elimination units. However, the static elimination apparatus 200 may operate only the non-contact static elimination unit 58, without operating the contact static elimination unit 57, to eliminate static charge from the sheet S. For example, sheets having a low electrical resistance, such as plain paper, can be sufficiently eliminated by using only the non-contact static elimination unit 58 without using the contact static elimination unit 57.

In contrast, for sheets that have high electrical resistance, such as synthetic paper, static charge can be eliminated from such sheets using both the contact static elimination unit 57 and the non-contact static elimination unit 58. Therefore, depending on the sheet type to be printed in each job, the user can freely change the settings of the static elimination apparatus 200 using the static elimination operation unit 54.

The static elimination operation unit 54 is disposed on the top surface 200a of the housing of the static elimination apparatus 200 (upper surface of the static elimination apparatus 200). The static elimination operation unit 54 may be provided on the front surface 200b of the housing of the static elimination apparatus 200 (front surface of the static elimination apparatus 200). According to the present embodiment, the static elimination operation unit 54 includes a mode lever 54a and dials 54b. The mode lever 54a is a selector switch used to manually turn ON or OFF (enable or disable) the voltage application to the static elimination roller 50 using the high-voltage circuit board 55. Even if the mode lever 54a is set to OFF, the sheet S is conveyed. Even if the mode lever 54a is set to OFF, the non-contact static elimination unit 58 performs the static elimination processing.

The dials 54b are thumb rotary switches used to manually set the voltage value to be applied to the static elimination roller 50 using the high-voltage circuit board 55. According to the embodiment, since the static elimination operation unit 54 has two manual setting members, namely, the mode lever 54a and the dials 54b, the user can change the setting of the mode lever 54a without changing the settings of the dials 54b.

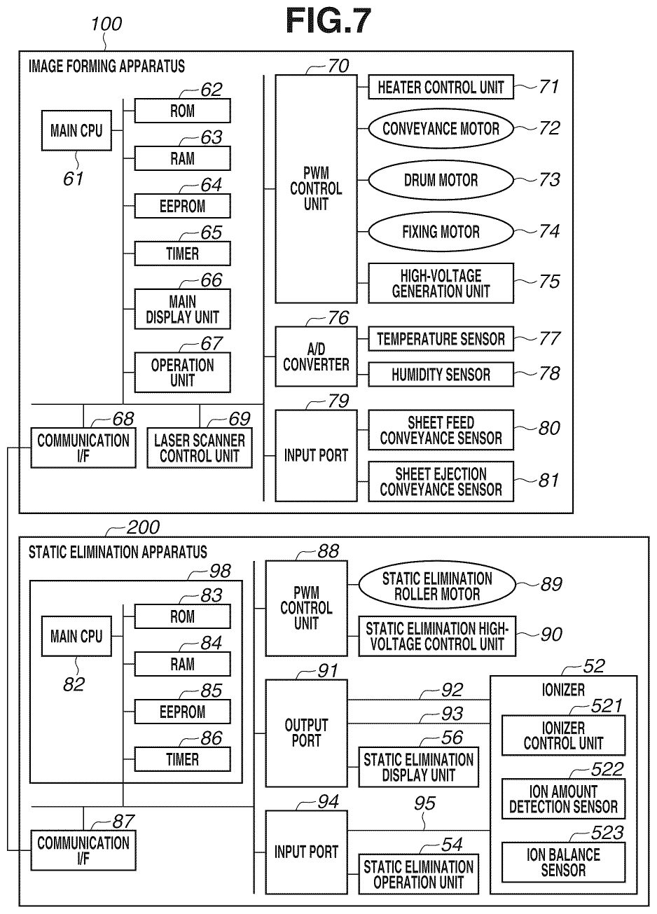

However, the value of the voltage to be applied to the static elimination roller 50 is not limited to one manually set by the user. The image forming apparatus 100 may transmit a sheet type to the static elimination apparatus 200, and a static elimination CPU 82 (see FIG. 7) of the static elimination apparatus 200 may determine the value of the voltage to be applied to the static elimination roller 50 based on the sheet type. The static elimination apparatus 200 may include a detection roller or a surface potential sensor for detecting the charge amount of the sheet. These members may measure the charge amount of the sheet S after the image formation, and the static elimination CPU 82 may determine the value of the voltage to be applied to the static elimination roller 50 according to the measured charge amount of the sheet S. A method for setting the value of the voltage to be applied to the static elimination roller 50 may be selected from manual setting by the user or automatic setting based on measurement of the sheet's charge amount by the detection roller or other sensors.

### Block Diagram of Image Forming System

FIG. 7 is a block diagram illustrating electrical configurations of the image forming apparatus 100 and the static elimination apparatus 200. The configuration of the image forming apparatus 100 will be described below. The image forming apparatus 100 includes the main CPU 61, a Read Only Memory (ROM) 62, a Random Access Memory (RAM) 63, an Electrically Erasable Programmable Read Only Memory (EEPROM) 64, a timer 65, the main display unit 66, an operation unit 67, a communication interface (I/F) 68, a laser scanner control unit 69, a Pulse Width Modulation (PWM) control unit 70, an analog-to-digital (A/D) converter 76, and an input port 79. These components are connected via a system bus. Further, a heater control unit 71, a conveyance motor 72, a drum motor 73, a fixing motor 74, and a high-voltage generation unit 75 are connected to the PWM control unit 70. A temperature sensor 77 and a humidity sensor 78 are connected to the A/D converter 76. A sheet feed conveyance sensor 80 and a sheet ejection conveyance sensor 81 is connected to the input port 79.

The main CPU 61 comprehensively controls image processing and printing based on stored programs and other data.

Programs and data necessary for the main CPU 61 to execute various processes are stored in the ROM 62 and the EEPROM 64. The RAM 63 functions as a working area. The timer 65 is used by the main CPU 61 to perform various timing control. The main display unit 66 displays setting information about the image forming apparatus 100 and print job processing statuses, among other types of information. The operation unit 67 receives inputs for various settings and operation instructions from the user. The communication I/F 68 is connected to the static elimination apparatus 200 via a communication cable, and performs communication to control the corresponding apparatuses.

The laser scanner control unit 69 is a device for irradiating each photosensitive drum 1 which has been charged to form an electrostatic latent image with a laser beam modulated according to image data. The laser scanner control unit 69 irradiates each photosensitive drum 1 which has been uniformly charged to a negative potential by the high-voltage generation unit 75 (described below), with a laser beam while deflecting the laser beam using a polygon mirror. Thus, the negative charge on the portions of the photosensitive drum 1 irradiated with the laser beam are neutralized, and an electrostatic latent image is formed.

The PWM control unit 70 controls the heater control unit 71, the conveyance motor 72, the drum motor 73, the fixing motor 74, and the high-voltage generation unit 75. The heater control unit 71 controls the temperature of the fixing apparatus 30. The conveyance motor 72 drives the conveyance roller and the pre-fixing conveyance device 31 for sheet conveyance. The drum motor 73 rotationally drives the photosensitive drum 1. The fixing motor 74 drives a fixing belt and the like of the fixing apparatus 30. The A/D converter 76 performs A/D conversion to convert analog signals output from the temperature sensor 77 and the humidity sensor 78 into digital signals. The input port 79 receives output signals from the sheet feed conveyance sensor 80 and the sheet ejection conveyance sensor 81.

The configuration of the static elimination apparatus 200 will now be described below. The static elimination apparatus 200 includes the static elimination CPU 82, a ROM 83, a RAM 84, an EEPROM 85, a timer 86, a communication I/F 87, a PWM control unit 88, an output port 91, and an input port 94. According to the present embodiment, the static elimination control unit 98 includes the static elimination CPU 82, the ROM 83, the RAM 84, the EEPROM 85, and the timer 86. These components are connected via a system bus. A static elimination roller motor 89 and a static elimination high-voltage control unit 90 are connected to the PWM control unit 88. The output port 91 outputs an ionizer ON/OFF signal 92 and a maintenance detection mode transition signal 93. The static elimination display unit 56 is further connected to the output port 91, and the output port 91 outputs data corresponding to information to be displayed on the static elimination display unit 56. A maintenance detection signal 95 is input to the input port 94, and the static elimination operation unit 54 is connected to the input port 94. The ionizer 52 receives, as inputs, the ionizer ON/OFF signal 92 and the maintenance detection mode transition signal 93, and outputs the maintenance detection signal 95.

The static elimination CPU 82 performs various controls necessary for eliminating static charge from the sheets and ejecting the sheets based on stored programs and other data. The ROM 83 and the EEPROM 85 store programs and data necessary for the static elimination CPU 82 to perform various types of processing. The RAM 84 functions as a working area. The timer 86 is used for the static elimination CPU 82 to control various timings, and for measuring the operation time of the ionizer 52. The communication I/F 87 is connected to the image forming apparatus 100 via a communication cable, and performs communication to control each apparatus.

The PWM control unit 88 controls the static elimination roller motor 89 and the static elimination high-voltage control unit 90 to elimination static charge from the sheet ejected from the image forming apparatus 100 and convey the sheet. The output port 91 outputs the ionizer ON/OFF signal 92, the maintenance detection mode transition signal 93, and an ON/OFF state of the static elimination display unit 56. The input port 94 receives the maintenance detection signal 95 and an ON/OFF state of the static elimination operation unit 54.

The ionizer 52 switches between ion generation and stop states according to the ionizer ON/OFF signal 92. If the ionizer ON/OFF signal 92 is at a high (H) level, the ionizer 52 switches to the ion generation state. If the ionizer ON/OFF signal 92 is at a low (L) level, the ionizer 52 switches to the ion stop state. The static elimination CPU 82 changes the ionizer ON/OFF signal 92 at a predetermined timing to control the ion generation and stop states.

The maintenance detection mode transition signal 93 causes the ionizer 52 to enter the maintenance detection mode, in which whether the maintenance of the electrode portions is necessary is determined. The static elimination CPU 82 changes the maintenance detection mode transition signal 93 from the L level to the H level at a predetermined timing to cause the ionizer 52 to enter the maintenance detection mode. The maintenance detection mode transition signal 93 then switches back from the H level to the L level 100 milliseconds (ms) after the transition from the L level to the H level.

The maintenance detection signal 95 is output when the ionizer control unit 521 determines that the maintenance of the electrode portions is necessary in the maintenance detection mode for the ionizer 52. More specifically, the ionizer control unit 521 switches the ionizer 52 to the maintenance detection mode, in which whether maintenance is necessary is determined, triggered by the transition of the maintenance detection mode transition signal 93 from the L level to the H level. The ionizer control unit 521 determines the necessity of the maintenance in the maintenance detection mode. The necessity of the maintenance determined by the ionizer control unit 521 is reflected in the maintenance detection signal 95. More specifically, the maintenance detection signal 95 indicates that the maintenance is unnecessary if a predetermined time has elapsed with the maintenance detection signal 95 remaining at the L level, and the maintenance detection signal 95 indicates that the maintenance is necessary if the predetermined time has elapsed with the maintenance detection signal 95 remaining at the H level. In the maintenance detection mode, the ionizer control unit 521 continues the maintenance necessity detection until the maintenance detection signal 95 reaches the H level or the predetermined time elapses.

If the ionizer control unit 521 outputs the maintenance detection signal 95 at the H level to the static elimination CPU 82, the static elimination CPU 82 displays a maintenance warning for recommending the maintenance of the ionizer 52 on the main display unit 66 via the communication I/F 87. In the following descriptions, the state where the maintenance detection signal 95 is at the H level corresponds to the state where the maintenance detection signal 95 is output.

The ionizer 52 includes the ionizer control unit 521, an ion amount detection sensor 522 for detecting an ion amount, and an ion balance sensor 523 for detecting the balance between positive and negative ions. The ionizer control unit 521 determines whether the ionizer 52 can output ions at a normal ion amount and ion balance by using the ion amount detection sensor 522 and the ion balance sensor 523 in the maintenance detection mode.

### Maintenance Detection Control by Ionizer

If the ionizer 52 detects the maintenance detection mode transition signal 93, the ionizer 52 performs the maintenance necessity detection. More specifically, if the ionizer 52 detects the maintenance detection mode transition signal 93, the ionizer 52 starts operation, and the ion amount detection sensor 522 detects the amount of generated ions per unit time. If the detected amount of generated ion is less than a predetermined amount with application of a specified voltage to the static elimination needles 520, the ionizer control unit 521 outputs the maintenance detection signal 95.

If the detected amount of generated ion is equal to or larger than the predetermined amount, the ionizer control unit 521 gradually increases the positive or negative voltage to be applied to the static elimination needles 520 so that the ion balance detected by the ion balance sensor 523 falls within a predetermined range. According to the present embodiment, the static elimination needles 520 are alternately and repetitively applied with a positive voltage (high-voltage pulse with the positive polarity) and a negative voltage (high-voltage pulse with the negative polarity). More specifically, the ionizer control unit 521 performs feedback control to adjust the ion balance between positive and negative ions by increasing the amplitude of the positive or negative voltage. In other words, the ionizer control unit 521 controls the positive or negative voltage so that the ion balance detected by the ion balance sensor 523 approaches zero. Here, the ion balance being within the predetermined range means that the difference between the amounts of positive and negative ions generated by each of the ionizers 52a and 52b in the upper unit 401 and the lower unit 402, respectively, is within the predetermined range.

If the ionizer 52 increases the voltage to be applied to the static elimination needles 520 up to a specified upper limit and the ion balance still does not fall within the predetermined range, the ionizer control unit 521 outputs the maintenance detection signal 95. On the other hand, even if the ion balance falls within the predetermined range, the ionizer control unit 521 continues the maintenance detection control for 30 seconds from the detection of the maintenance detection mode transition signal 93. The maintenance detection control ends 30 seconds after the detection of the maintenance detection mode transition signal 93.

More specifically, the ionizer control unit 521 outputs the maintenance detection signal 95 in a case where the amount of ion generated by the ionizer 52 is less than a predetermined ion amount and in a case where the ion balance does not fall within the predetermined range. According to the present embodiment, the ionizer 52 includes the ion amount detection sensor 522 and the ion balance sensor 523. However, the present embodiment is not limited thereto. The ionizer control unit 521 may calculate the ion generation amount and the ion balance based on positive and negative ion currents (return currents) that return to the ionizer circuits via ground.

According to the present embodiment, the ionizer detection processing detects whether the maintenance of the ionizer 52 is necessary. However, the present embodiment is not limited thereto. The ionizer detection processing may detect stains of the ionizer 52 or measure the performance of the ionizer 52.

### Screen Display on User Operation Unit

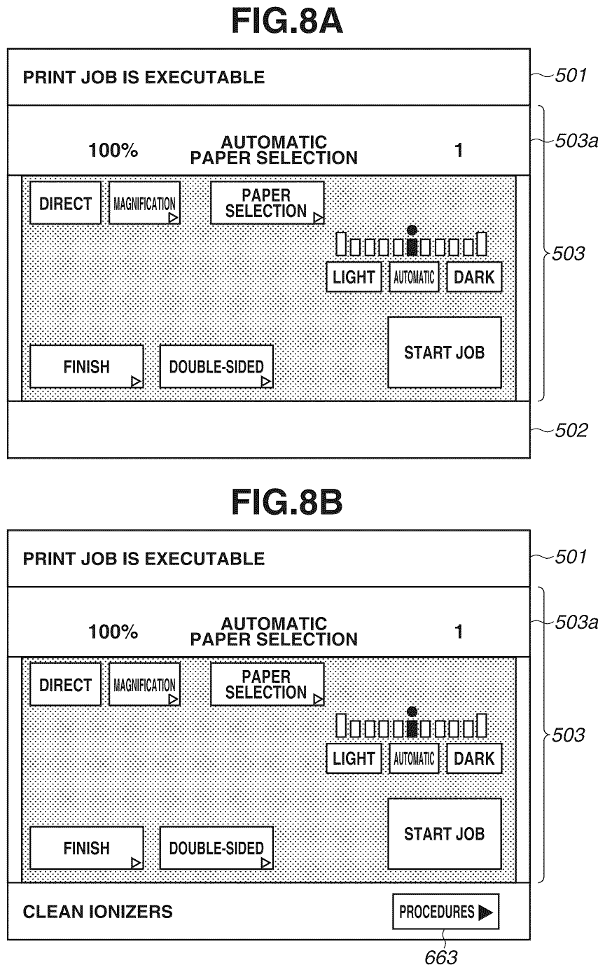

FIGS. 8A and 8B illustrate display contents on the main display unit 66 of the image forming apparatus 100. The main display unit 66 displays setting information for the image forming apparatus 100, print job processing statuses, and the like. According to the present embodiment, the main display unit 66 is a touch panel, which not only displays setting information and print job processing statuses but also receives inputs for various settings and operation instructions from the user.

The display screen includes an upper status area 501, on the upper side of the display screen, for displaying statuses of the image forming apparatus 100, and a lower status area 502, on the lower side of the display screen, for displaying warnings of the image forming apparatus 100 and the static elimination apparatus 200. The display screen further includes a job setting area 503 used by the user to set job details, between the upper status area 501 and the lower status area 502. The upper part of the job setting area 503 is provided with a setting display area 503a for displaying settings set by the user when inputting a job to the image forming apparatus 100. The upper status area 501 mainly displays whether execution of a print job is possible, in progress, or not executable.

FIG. 8A illustrates the screen displayed on the main display unit 66 if the maintenance detection signal 95 is not output. FIG. 8B illustrates the screen displayed on the main display unit 66 if the maintenance detection signal 95 has been output. More specifically, the screen illustrated in FIG. 8A displays no message for promoting the user to clean the ionizer 52. The screen in FIG. 8B displays a message for promoting the user to clean the ionizer 52. According to the present embodiment, the main CPU 61 can receive a job even if a maintenance warning of the ionizer 52 is issued. Thus, the screen in FIG. 8B displays a message for promoting the user to clean the ionizer 52 in the lower status area 502, and a message indicating that a job is acceptable in the upper status area 501.

As illustrated in the screen in FIG. 8B, if the maintenance detection signal 95 has been output, the lower status area 502 displays a guidance key 663 for displaying a guidance of cleaning procedures. If the user presses the guidance key 663, the guidance of cleaning procedures appears on the screen. More specifically, the cleaning procedure may include instructions on how the user can access the electrode portions of the ionizer 52 and how to clean each part using the respective cleaning tools, which may be explained using illustrations, messages, videos, or the like. For example, as procedures for accessing the electrode portions of the ionizer 52, the guidance may display instructions to lift the upper unit 401 of the static elimination apparatus 200.

According to the present embodiment, a notification promoting the user to perform the cleaning of the ionizer 52 is provided using the main display unit 66 of the image forming apparatus 100. However, the present embodiment is not limited thereto. The notification promoting the user to perform the cleaning of the ionizer 52 may be provided using the static elimination display unit 56 of the static elimination apparatus 200. For example, such a notification may be indicated by changing the display color, the light intensity, or the blinking period of the light emitting diode (LED) of the static elimination display unit 56. For example, the notification may be issued to the user by displaying a text or the like on a display of the static elimination display unit 56. Both the main display unit 66 and the static elimination display unit 56 may be used together for such notifications.

### Descriptions of Flowcharts

Continuous use of the ionizer 52 may result in a decrease in the static elimination performance of the ionizer 52. Thus, the user can perform maintenance on the ionizer 52 at a suitable timing. However, in a case where jobs that individually do not reach the threshold for executing maintenance necessity detection are repetitively executed, the ionizer control unit 521 cannot perform the maintenance necessity detection of the ionizer 52, and may continue executions of the jobs with decreased elimination capability.

Thus, according to the present embodiment, two threshold values for execution of the maintenance necessity detection are provided, specifically, a first threshold value for the cumulative operation time of the ionizer 52, and a second threshold value for the operation time of the ionizer 52 in the immediately preceding job. The static elimination CPU 82 performs the maintenance necessity detection in a case where the condition of at least one of the first and the second threshold values is satisfied.

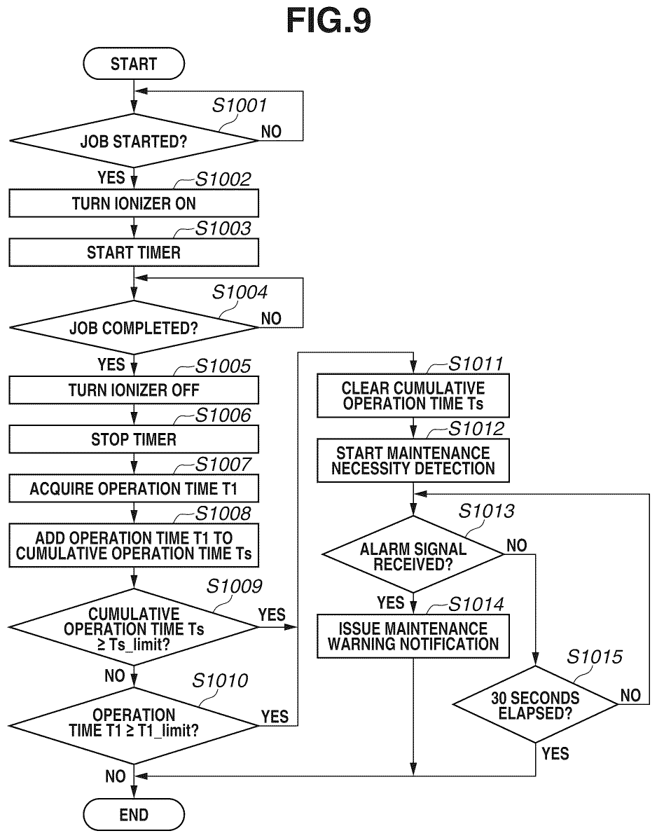

FIG. 9 is a flowchart illustrating control performed by the static elimination CPU 82 of the static elimination control unit 98.

In step S1001, the static elimination CPU 82 acquires sheet information from the main CPU 61 via the communication I/F 87 to determine whether to start a job. If the job is started (YES in step S1001), the processing proceeds to step S1002. In step S1002, the static elimination CPU 82 changes the ionizer ON/OFF signal 92 from the L level to the H level to start the output of the ionizer 52. In step S1003, the static elimination CPU 82 instructs the timer 86 to start the measurement of the operation time of the ionizer 52. In step S1004, in response to the sheet S with an image formed thereon having passed through the ionizer 52, the static elimination CPU 82 determines whether the print job is completed.

More specifically, the static elimination CPU 82 determines whether the last sheet of the print job has passed through the ionizer 52. If the last sheet has passed through the ionizer 52 (YES in step S1004), the processing proceeds to step S1005. In step S1005, the static elimination CPU 82 changes the ionizer ON/OFF signal 92 from the H level to the L level to stop the output of the ionizer 52. In step S1006, the static elimination CPU 82 stops the measurement of the operation time of the ionizer 52 using the timer 86.

In step S1007, the static elimination CPU 82 acquires an operation time T1 of the ionizer 52 measured with the timer 86 and stores the operation time T1 in a memory. In addition, a cumulative operation time Ts, which is the total of the operating times T1 of the ionizer 52 for the respective jobs since the previous execution of maintenance necessity detection, is stored in the memory. In step S1008, the static elimination CPU 82 adds the operation time T1 of the ionizer 52 in the present job to the cumulative operation time Ts. The cumulative operation time Ts is stored in a nonvolatile memory.

Then, the static elimination CPU 82 determines whether the cumulative operation time Ts is equal to or greater than the first threshold value of 600 seconds. If the static elimination CPU 82 determines that the cumulative operation time Ts is equal to or greater than 600 seconds (YES in step S1009), the processing proceeds to step S1011. In step S1011, the static elimination CPU 82 initializes the cumulative operation time Ts to zero. In step S1012, the static elimination CPU 82 changes the maintenance detection mode transition signal 93 from the L level to the H level to cause the ionizer 52 to start the maintenance necessity detection.

If the static elimination CPU 82 determines that the cumulative operation time Ts is less than 600 seconds, (NO in step S1009), the processing proceeds to step S1010. In step S1010, the static elimination CPU 82 determines whether the operation time T1 of the immediately preceding job is equal to or greater than the second threshold value of 300 seconds. If the operation time T1 of the ionizer 52 in the immediately preceding job is equal to or greater than the second threshold value of 300 seconds (YES in step S1010), the processing proceeds to step S1011. In step S1011, the static elimination CPU 82 initializes the cumulative operation time Ts to zero. In step S1012, the static elimination CPU 82 changes the maintenance detection mode transition signal 93 from the L level to the H level to cause the ionizer 52 to start the maintenance necessity detection. If the operation time T1 of the ionizer 52 in the immediately preceding job is less than 300 seconds (NO in step S1010), the processing of the flowchart ends.

If the static elimination CPU 82 receives the maintenance detection signal 95 from the ionizer 52 (YES in step S1013), the processing proceeds to step S1014. In step S1014, the static elimination CPU 82 issues a maintenance warning notification to the main CPU 61 via the communication I/F 87. Then, the processing exits the flowchart. In response to receiving the maintenance warning notification from the static elimination CPU 82, the main CPU 61 displays a maintenance warning for recommending the cleaning of the ionizer 52 on the main display unit 66 (see FIG. 8B).

If the static elimination CPU 82 does not receive the maintenance detection signal 95 within 30 seconds after the static elimination CPU 82 causes the ionizer 52 to start the maintenance necessity detection (YES in step S1015), the processing of flowchart ends. In other words, if a predetermined time has elapsed with the maintenance detection signal 95 remaining at the L level, this indicates that maintenance necessity detection has been successfully performed for the predetermined time. In this case, cleaning of the ionizer 52 is not necessary, so that the static elimination CPU 82 does not display the maintenance warning for recommending the cleaning of the ionizer 52 on the main display unit 66 (the screen in FIG. 8A appears).

According to the embodiment, 30 seconds from the start of maintenance necessity detection serves as the threshold value for determining whether the cleaning of the ionizer 52 is necessary. However, the threshold value is not limited thereto. The threshold value for determining whether the cleaning of the ionizer 52 is necessary may be suitably set.

If the maintenance warning (see FIG. 8B) appears on the main display unit 66, the user cleans the ionizer 52. If the door sensor 202 (see FIG. 3) detects that the door 250 is closed and if information indicating that the maintenance is necessary is stored in a memory, the static elimination CPU 82 instructs the ionizer 52 to perform the maintenance necessity detection. If, after the door 250 is closed, the result of the maintenance necessity detection indicates that maintenance of the ionizer 52 is unnecessary, the static elimination CPU 82 displays the screen as illustrated in FIG. 8A on the main display unit 66 via the communication I/F 87.

To determine whether to perform the maintenance necessity detection, the present embodiment provides a first threshold value Ts_limit, which is compared with the cumulative operation time Ts of the ionizer 52, and a second threshold value T1_limit, which is compared with the operation time T1 of the ionizer 52. The cumulative operation time Ts refers to the total operation times T1 of the ionizer 52 for the respective jobs since completion of the last maintenance necessity detection. According to the present embodiment, the first threshold value Ts_limit is set to 600 seconds and the second threshold value T1_limit is set to 300 seconds, However, these values are not limiting and may be set as appropriate. In other words, it is sufficient that the second threshold value T1_limit be set to a value less than the first threshold value Ts_limit. Desirably, the second threshold value T1_limit is set to a value equal to or less than half of the first threshold value Ts_limit.

According to the present embodiment, the operation time T1 stored in the memory together with the value of the timer 86 is cleared before the measurement with timer 86 is started in step S1003. In other words, the measurement of the timer 86 is started from zero in each job.

More specifically, the static elimination control unit 98 performs the static elimination processing and the maintenance necessity detection processing. The static elimination processing refers to processing for eliminating static charge from a plurality of conveyed sheets by using the ionizer 52. The maintenance necessity detection processing refers to processing for detecting whether the maintenance of the ionizer 52 is necessary. The static elimination control unit 98 does not perform the maintenance necessity detection processing during execution of the static elimination processing for eliminating static charge from a plurality of sheets but performs the processing after completion of the static elimination processing. More specifically, the static elimination processing runs from the start of a job (YES in step S1001) until the job ends and the timer 86 stops (step S1006). The maintenance detection processing runs from the start of the maintenance necessity detection (step S1012) until either the issuance of the maintenance warning notification (step S1014) or 30 seconds after the start of the maintenance necessity detection (step S1012) (YES in step S1015).

The static elimination control unit 98 and the ionizer control unit 521 are examples of control units. The static elimination processing and the maintenance necessity detection processing may be performed by the static elimination control unit 98 or the ionizer control unit 521.

In other words, the static elimination control unit 98 performs the maintenance necessity detection processing if the cumulative operation time Ts, which is the total of the operation times T1 of the ionizer 52 in a plurality of elimination processing operations is equal to or greater than the first threshold value. Further, even if the cumulative operation time Ts is smaller than the first threshold value, the static elimination control unit 98 performs the maintenance necessity detection processing if the operation time T1 of the ionizer 52 in a single piece of the static elimination processing is equal to or greater than the second threshold value which is less than the first threshold value.

In other words, the static elimination control unit 98 performs the maintenance necessity detection processing if the cumulative operation time Ts, which is the total of the operation times T1 of the ionizer 52 in a plurality of jobs, is equal to or greater than the first threshold value. Further, with the cumulative operation time Ts less than the first threshold value, if the operation time T1 of the ionizer 52 in one job is equal to or greater than the second threshold value which is less than the first threshold value, the static elimination control unit 98 performs the maintenance necessity detection processing.

According to the present embodiment, for the ionizer 52, the ionizer ON/OFF signal 92 remains at the H level from the start of a job until the job ends and the ionizer turns OFF. However, the static elimination CPU 82 may switch the ionizer ON/OFF signal 92 between the H and L levels in synchronization with the timing of sheet conveyance. More specifically, the static elimination CPU 82 may set the ionizer ON/OFF signal 92 to the L level between the time when the trailing edge of the preceding sheet passes and the time when the leading edge of the following sheet passes, and set the ionizer ON/OFF signal 92 to the H level only when the sheet passes through the ionizer 52. Even in this case, the operation time T1 of the ionizer 52 may be the time period from the time when the ionizer 52 are turned ON (step S1002) at the start of a job until the time when the ionizer 52 are turned OFF (step S1005) at the end of the job, as illustrated in the flowchart in FIG. 9. However, the time period is not limited thereto. The operation time T1 may be a cumulative value of the time period during which the ionizer 52 remains ON in a single static elimination processing operation. However, static elimination performed by the ionizer 52 is unstable immediately after switching from the ion generation stop state to the ion generation state of the ionizer 52, so that the ionizer 52 in the ion generation state can be kept throughout the job from start to finish.

The cumulative operation time Ts represents the total of the operation times T1 of the ionizer 52 in the static elimination processing. In other words, the cumulative operation time Ts does not include the operation time of the ionizer 52 in the maintenance necessity detection processing.

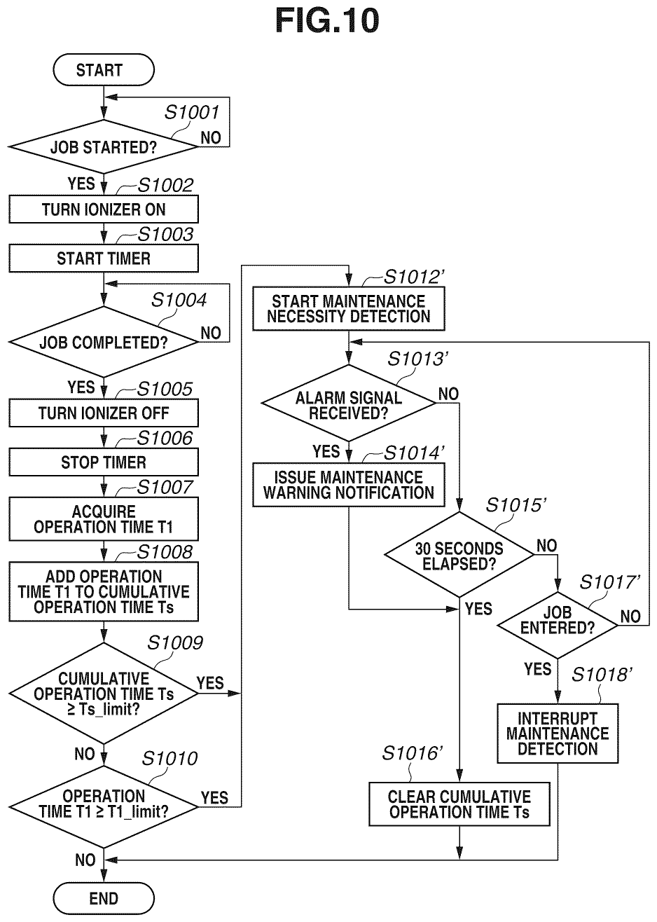

FIG. 10 illustrates a modification of the flowchart of control performed by the static elimination CPU 82 of the static elimination control unit 98. According to the present embodiment, if a job is input during execution of the maintenance necessity detection, the static elimination CPU 82 interrupts the maintenance necessity detection. If the maintenance necessity detection is interrupted, the cumulative operation time Ts is not cleared. The operations in steps S1001 to S1010 in FIG. 10 are similar to those in steps S1001 to S1010 in FIG. 9, respectively, and redundant descriptions thereof are omitted.

In step S1012′, the static elimination CPU 82 changes the maintenance detection mode transition signal 93 from the L level to the H level to cause the ionizer 52 to start the maintenance necessity detection. If the static elimination CPU 82 receives the maintenance detection signal 95 from the ionizer 52 (YES in step S1013′), the processing proceeds to step S1014′. In step S1014′, the static elimination CPU 82 issues a maintenance warning notification to the main CPU 61. In step S1016′, the static elimination CPU 82 initializes the cumulative operation time Ts to zero. Then, the processing of the flowchart ends. In step S1014′, the static elimination CPU 82 issues a maintenance warning notification to the main CPU 61 via the communication I/F 87. In response to receiving the maintenance warning notification, the main CPU 61 displays a maintenance warning for recommending the cleaning of the ionizer 52 on the main display unit 66 (see FIG. 8B).

If 30 seconds elapse after the static elimination CPU 82 causes the ionizer 52 to start the maintenance necessity detection and the static elimination CPU 82 does not receive the maintenance detection signal 95 (YES in step S1015′), the processing proceeds to step S1016′. In step S1016′, the static elimination CPU 82 initializes the cumulative operation time Ts to zero. Then, the processing of the flowchart ends.

If the next job is input during execution of the maintenance necessity detection (YES in step S1017′), the processing proceeds to step S1018′. In step S1018′, the static elimination CPU 82 interrupts the maintenance necessity detection. Then, the processing of the flowchart ends. In this case, the cumulative operation time Ts is not initialized to zero and is carried over for use in the next job.

More specifically, if the ionizer 52 completes the maintenance necessity detection, the cumulative operation time Ts is initialized to zero. If the ionizer 52 does not complete the maintenance necessity detection because the next job is input, the cumulative operation time Ts is not initialized.

In the flowchart in FIG. 9, the static elimination CPU 82 may initialize the cumulative operation time Ts after completion of the maintenance necessity detection. Specifically, instead of initializing the cumulative operation time Ts in step S1011, the static elimination CPU 82 may initialize the cumulative operation time Ts after the maintenance warning notification (step S1014) or after 30 seconds have elapsed since the start of maintenance necessity detection (YES in step S1015).

According to the present embodiment, whether to perform the maintenance necessity detection is determined based on an operation time of the ionizer 52 and a threshold value for the operation time. However, this is not limiting. The determination may be made based on the number of supplied sheets and a threshold value for the number of supplied sheets. More specifically, a counter for counting the number of supplied sheets may be used, instead of using the timer 86 for measuring time. The counter counts the number of sheets having passed through the ionizer 52 from the start of the job until the job ends. The static elimination CPU 82 adds a count value C1, which is counted, to a cumulative count value Cs. The cumulative count value Cs represents the total of the count values C1 in the respective jobs since completion of the last maintenance necessity detection of the ionizer 52. Then, the static elimination CPU 82 compares the cumulative count value Cs with a first threshold sheet number Cs_limit. If the cumulative count value Cs is equal to or greater than the first threshold sheet number Cs_limit, the static elimination CPU 82 causes the ionizer 52 to perform the maintenance necessity detection. If the cumulative count value Cs is less than the first threshold sheet number Cs_limit, and the count value C1 is equal to or greater than a second threshold sheet number C1_limit, the static elimination CPU 82 causes the ionizer 52 to perform the maintenance necessity detection. According to the present embodiment, the cumulative count value Cs is an example of the cumulative number of supplied sheets, and the count value C1 is an example of the number of sheets that have passed.

More specifically, if the cumulative number of sheets having passed through the non-contact static elimination unit in a plurality of elimination processing operations is equal to or greater than the first threshold sheet number C_slimit, the static elimination control unit 98 performs the maintenance necessity detection processing. Further, if, with the cumulative number of sheets less than the first threshold sheet number Cs_limit, the number of sheets that have passed in each of the static elimination processing operation is equal to or greater than the second threshold sheet number C1_limit which is smaller than the first threshold sheet number Cs_limit, the static elimination control unit 98 performs the maintenance necessity detection processing.

In other words, if the cumulative number of sheets having passed through the non-contact static elimination unit in a plurality of jobs is equal to or greater than the first threshold sheet number Cs_limit, the static elimination control unit 98 performs the maintenance necessity detection processing. Further, if, with the cumulative number of sheets smaller than the first threshold sheet number Cs_limit, the number of passing sheets in a single job is equal to or greater than the second threshold sheet number C1_limit, which is smaller than the first threshold sheet number Cs_limit, the static elimination control unit 98 performs the maintenance necessity detection processing.

In other words, the present embodiment provides a first reference relating to the cumulative operation time of the ionizer 52 and a second reference corresponding to the job immediately preceding the maintenance necessity detection for determination as to whether to perform the maintenance necessity detection. The static elimination control unit 98 may determine whether to perform the maintenance necessity detection based on time and the number of sheets in combination. For example, the first threshold value Ts_limit corresponding to the cumulative operation time Ts is used as the first reference, and the second threshold value C1_limit corresponding to the count value C1 of the number of sheets is used as the second reference. However, desirably, the first reference indicating the cumulative operation time of the ionizer 52, and the second reference corresponding to the immediately preceding job are unified to either the number of sheets or time.

As described above, the static elimination control unit 98 not only compares the cumulative operation time Ts since execution of the last maintenance necessity detection with the first threshold value but also compares the immediately preceding operation time of the ionizer 52 with the second threshold value. Thus, the maintenance necessity detection can be performed at a suitable timing even in a case where prolonged print jobs are executed in succession. This configuration can reduce the possibility of a stacking failure of print products caused by job execution with the degraded elimination capability of the ionizer 52.

According to the present embodiment, the ionizer 52 is used as the non-contact static elimination unit 58, but this is not limiting. A corotron may also be used. According to the present embodiment, the contact static elimination unit 57 applies a voltage to a static elimination roller 50 to bring the surface potential of the sheet close to zero, but this is not limiting. The static elimination apparatus 200 also includes a function as a charge adjustment apparatus that supplies electric charge to the sheet via the static elimination roller 50 serving as an electric charge supply member to adjust the charge state of the sheet. The charge adjustment apparatus does not necessarily reduce the amount of electric charge of the sheet (i.e., does not always perform static elimination). For example, in a state where sheets are stacked after completion of the processing performed by the charge adjustment apparatus, the charge adjustment apparatus may adjust the amount of electric charge on each surface of the sheets so that the surfaces of adjacently stacked sheets facing each other are charged to the same polarity. More specifically, the charge adjustment apparatus applies a voltage so that the electrostatic polarity of the sheet surface is reversed for every other one of a plurality of sheets. In other words, the voltage is set to a level at which the sheet's surface electrostatic polarity is reversed, and the voltage application is performed on every other sheet. This configuration reduces adhesion between sheets caused by electrostatic force because the surfaces of adjacently stacked sheets facing each other are charged to the same polarity. However, sheets having been subjected to the charge adjustment processing by the charge adjustment apparatus as described above have a large charge amount, making them prone to sticking to the conveyance path and causing conveyance failures. To reduce sheet conveyance failures, the charge adjustment apparatus may include the non-contact static elimination unit 58 downstream of a roller for sheet charge adjustment so that static charge is eliminated from the sheet via the non-contact static elimination unit 58. Even in this case, it is desirable that the static elimination control unit 98 cause the ionizer 52 to perform the maintenance necessity detection at a suitable timing, and the static elimination control unit 98 can determine whether to perform the maintenance necessity detection based on the cumulative operation time of the ionizer 52 and the operation time in the immediately preceding job.

In the above-described embodiment, the image forming system has been described as applied to the electrophotographic image forming system 300, but this is not limiting. The image forming system may be applied to an inkjet recording system employing an inkjet recording method.

The present disclosure makes it possible to perform, at a suitable timing, the detection processing for detecting whether the maintenance of a non-contact static elimination unit is necessary.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to Japanese Patent Application No. 2024-220510, which was filed on Dec. 17, 2024 and which is hereby incorporated by reference herein in its entirety.

What is claimed is:

1. A static elimination apparatus comprising:
a non-contact static elimination unit including an electrode portion for generating ions and configured to eliminate static charge from a sheet on which an image has been formed by an image forming unit, without contacting the sheet; and
a control unit configured to perform, using the non-contact static elimination unit, static elimination processing for eliminating static charge from a plurality of sheets conveyed from the image forming unit during execution of a job and perform detection processing for detecting whether a maintenance of the electrode portion is necessary after completion of the job,
wherein, in a case where a cumulative operation time as a total of an operation time of the non-contact static elimination unit since a previous execution of the detection processing is equal to or greater than a first threshold value, the control unit performs the detection processing, and
wherein, in a case where the operation time of the non-contact static elimination unit in a single job is equal to or greater than a second threshold value smaller than the first threshold value, the control unit performs the detection processing.

2. The static elimination apparatus according to claim 1, wherein the cumulative operation time is a total operation time of the non-contact static elimination unit for a plurality of jobs.

3. The static elimination apparatus according to claim 1, wherein, in a case where a job is input during execution of the detection processing, the detection processing is interrupted.

4. The static elimination apparatus according to claim 3,
wherein, in a case where the detection processing is completed, the cumulative operation time is initialized, and
wherein, in a case where a job is input during execution of the detection processing, the cumulative operation time is not initialized.

5. The static elimination apparatus according to claim 1,
wherein, in a case where an alarm signal is received during execution of the detection processing, the control unit determines that the maintenance of the non-contact static elimination unit is necessary, and
wherein, in a case where the detection processing has continued for a predetermined time without reception of the alarm signal, the control unit determines that the maintenance of the non-contact static elimination unit is unnecessary.

6. The static elimination apparatus according to claim 1, wherein the second threshold value is equal to or less than half of the first threshold value.

7. The static elimination apparatus according to claim 1, further comprising a display unit configured to indicate that cleaning of the non-contact static elimination unit is recommended.

8. The static elimination apparatus according to claim 1, further comprising a contact static elimination unit disposed downstream of the image forming unit in a sheet conveyance direction and configured to eliminate static charge from a sheet while contacting the sheet, wherein the non-contact static elimination unit is disposed downstream of the contact static elimination unit in the sheet conveyance direction.

9. An image forming system comprising:
the static elimination apparatus according to claim 1; and
the image forming unit.

10. A static elimination apparatus comprising:
a non-contact static elimination unit including an electrode portion for generating ions and configured to eliminate static charge from a sheet on which an image has been formed by an image forming unit, without contacting the sheet; and
a control unit configured to perform, using the non-contact static elimination unit, static elimination processing for eliminating static charge from a plurality of sheets conveyed to the non-contact static elimination unit during execution of a job, and perform, after the static elimination processing, detection processing for detecting whether a maintenance of the electrode portion is necessary after completion of the job,
wherein, in a case where a cumulative number of sheets as a total number of sheets that have passed through the non-contact static elimination unit since a previous execution of the detection processing is equal to or greater than a first threshold value, the control unit performs the detection processing, and
wherein, in a case where a number of sheets that have passed through the non-contact static elimination unit in a single job is equal to or greater than a second threshold value smaller than the first threshold value, the control unit performs the detection processing.

11. The static elimination apparatus according to claim 10, wherein the cumulative number of sheets is a number of sheets that have passed through the non-contact static elimination unit in a plurality of jobs.
